(19) United States
(12) Patent Application Publication
(10) Pub. No.: US 2005/0147732 A1
(43) Pub. Date: Jul. 7, 2005

(54) Method for preparing a food product comprising texturizers

(75) Inventors: Khadija Schwach-Abdellaoui, Frederiksberg C (DK); Jorgen Thorball, Virum (DK); Rikke Malene Joergensen, Birkeroed (DK)

Correspondence Address: NOVOZYMES NORTH AMERICA, INC., 500 FIFTH AVENUE, SUITE 1600, NEW YORK, NY, 10110, US

(73) Assignee: Novozymes Biopolymer A/S, Bagsvaerd (DK)

(21) Appl. No.: 11/016,640

(22) Filed: Dec. 17, 2004

Related U.S. Application Data
(60) Provisional application No. 60/531,120, filed on Dec. 19, 2003.

(30) Foreign Application Priority Data
Dec. 17, 2003 (DK) PA 2003 01868

(51) Int. Cl. A21D 10/00

(52) U.S. Cl. 426/656; 426/549; 426/658

(57) ABSTRACT

The present invention relates to a method for improving the textural properties of a non-dairy food product by using a combination of hyaluronic acid and a second texturizing agent for producing the food product.

### CROSS REFERENCE TO RELATED APPLICATIONS

This application claims priority or the benefit under 35 U.S.C. 119 of Danish application no. PA 2003 01868 filed Dec. 17, 2003 and U.S. provisional application No. 60/531,120 filed Dec. 19, 2003, the contents of which are fully incorporated herein by reference.

### BACKGROUND OF THE INVENTION

1. Field of the Invention

The present invention relates to a method for preparing a non-dairy food product, comprising hyaluronic acid and a second texturizer, a food product, a texturizing composition, and use of hyaluronic acid and a second texturizer for preparing a food product.

2. Description of Related Art

Glycosaminoglycans such as hyaluronic acid are negatively charged molecules, and have an extended conformation. Glycosaminoglycans are located primarily on the surface of cells or in the extracellular matrix. Glycosaminoglycans also have low compressibility in solution. As such, glycosaminoglycans are ideal as a lubricating fluid, and are found naturally in the joints. The rigidity of glycosaminoglycans provides structural integrity to cells and provides passageways between cells, allowing for cell migration.

Hyaluronic acid is also suspected of having a role in numerous physiological functions, such as adhesion, development, cell motility, cancer, angiogenesis, cartilage enhancement and wound healing.

U.S. Pat. No. 6,432,929 discloses a cartilage enhancing food supplement comprising hyaluronic acid.

In food products the texture, mouthfeel and stability may be enhanced by addition of texturising agents. These agents typically bind water and/or increase the viscosity of the product. Texturising agents may also be used to replace fat in low fat food products. Examples of texturising agents are gelatine and pectin.

It is an object of the present invention to provide a non-dairy food product with enhanced textural properties.

### SUMMARY OF THE INVENTION

The inventors have found that when hyaluronic acid and a second texturizer is added to a non-dairy food product it affects the textural properties of the food product to a greater extent than what can be achieved by adding hyaluronic acid or the second texturizing agent alone.

The invention thus relates in a first aspect to a method for preparing a non-dairy food product, comprising (a) mixing hyaluronic acid and a second texturizing agent with one or more additional food components; and (b) preparing a non-dairy food product, from the mixture resulting from step (a). In a second aspect the invention relates to a texturizing composition comprising hyaluronic acid and a second texturizing agent, and in further aspects to a non-dairy food product obtainable by the method of the invention, and to use of hyaluronic acid and a second texturizing agent for producing a non-dairy food product.

### DETAILED DESCRIPTION OF THE INVENTION

Hyaluronic Acid

In the context of the present invention the term “hyaluronic acid” covers hyaluronic acid as such as well as a salt of hyaluronic acid, a hyoluronate.

Hyaluronic acid is an unsulphated glycosaminoglycan with a simple structure of repeating disaccharide units of N-acetyl-glucosamine and D-glucuronic acid. The sugars are linked together by alternating beta-1,4 and beta-1,3 glycosidic bonds. Hyaluronic acid has a molecular weight usually in the range from about 100 kDa to about 4000 kDa.

The amount of hyaluronic acid is chosen so as to achieve the desired effect upon the texture of the product in combination with the second texturizing agent, and may vary depending on the product, the nature of the second texturizing agent, and the effect to be achieved. The amount of hyaluronic acid may e.g. be in the range 0.001-3% (weight/weight) of the food product, such as 0.002-2%, or 0.005-1%.

Sources of Hyaluronic Acid

A main commercial source of hyaluronic acid is chicken or rooster comb, which has hyaluronic acid at a higher concentration than other animal tissues. Another important source of hyaluronic acid is microorganisms, through a fermentation process. U.S. Pat. No. 4,801,539, (Akasaka, et al.) discloses a method for preparing hyaluronic acid. Yields from a strain of S. zooepidemicus are reported of about 3.6 g/l. In European patent EP0694616, yields of about 3.5 g/l are reported from fermentation processes using an improved strain of S. zooepidemicus.

In a preferred embodiment of the invention hyaluronic acid is in the form of a salt of hyaluronic acid, a hyaluronate, such as e.g. sodium hyaluronate, or calcium hyaluronate.

Hyaluronic acid according to the invention may be from any source known in the art, such as e.g. from rooster or chicken comb or from a microorganism. In a preferred embodiment hyaluronic acid is produced by a microorganism, such as e.g. by a strain of Streptococcus, such as e.g. S. zooepidemicus, a strain of Pasteurella, such as e.g. P. multocida, or a strain of Bacillus.

Second Texturizing Agent

It is to be understood that in the present context the term “second texturizing agent” is meant to cover a texturizing agent which is not hyaluronic acid.

A texturizing agent is a component that when present in small amounts affects the texture of a food product, e.g. a component that increases the viscosity and/or gel stiffness of a food product. Texturizing agents are often high molecular weight components capable of binding water in the product. The second texturizing agent of the invention may be any texturizing agent other than hyaluronic acid suitable for addition to a food product. The texturizing agent may e.g. be a carbohydrate such as e.g. starch, modified starch, pectin, carageenan, locust bean gum, an alginate, agar agar, xanthan gum, guar gum, gellan gum, microcrystalline cellulose, konjac, chitin, chitosan, or any combination thereof. The texturizing agent may also be a protein such as e.g. gelatine, whey protein, or casein.

In one embodiment of the invention the second texturizing agent is starch, such as e.g. wheat starch, corn starch, maize starch, waxy maize starch, potato starch, manioc starch, and/or tapioca starch. Starch may be from any source known in the art. The starch may be modified starch. Starch may be modified in any appropriate way known in the art, e.g. by replacing some of the hydroxyl groups with e.g. ester or ether groups, by cross binding of hydroxyl groups on neighbouring starch molecules, or by physical methods such as e.g. roll-drying, extrusion, spray drying, and heat/moisture treatment.

In another embodiment of the invention the second texturizing agent is pectin. Pectin may be from any source, e.g. from citrus fruits or apples. Pectin may be any kind of pectin, e.g. high ester pectin, low ester pectin, and/or amidated pectin. In high (methyl)ester or HM-pectin a relatively high portion of the carboxyl groups occur as methyl esters, and the remaining carboxylic acid groups in the form of the free acid or as its salts, e.g. ammonium, potassium, calcium, or sodium salts. Pectin in which less than 50% of the carboxyl acid units occur as the methyl ester is normally referred to as low (methyl)ester or LM-pectin. In general, low ester pectin is obtained from high ester pectin by a treatment at mild acidic or alkaline conditions. Amidated pectin can be obtained from high ester pectin when ammonia is used in the alkaline deesterification process. In this type of pectin some of the remaining carboxylic acid groups have been transformed into the acid amide.

The amount of texturizing agent is chosen so as to achieve the desired effect upon the texture of the product in combination with hyaluronic acid, and may vary depending on the product, the nature of the second texturizing agent, and the effect to be achieved. If the texturizing agent is starch the amount may e.g. be in the range 0.1-20% (weight/weight) of the food product, such as 0.2-10%, 0.5-5%, or 0.5-3%. If the second texturizing agent is pectin the amount may e.g. be in the range 0.01-10% (weight/weight) of the food product, such as 0.02-5%, 0.03-3%, or 0.05-2%.

The second texturizing agent may be formulated in any way suitable for the use in manufacture of a food product, e.g. the second texturizing agent may be mixed with other components, such as e.g. salts or sugars, e.g. suitable food grade buffer salts required for control of pH and/or sugars for stabilization purposes.

In one embodiment of the invention hyaluronic acid and second texturizing agent is used in amounts sufficient to increase the viscosity, gel stiffness, and/or mouthfeel of the food product compared to the food product without hyaluronic acid and second texturizing agent. In a further embodiment of the invention hyaluronic acid and second texturizing agent is used in amounts sufficient to increase the viscosity, gel stiffness, and/or mouthfeel of the food product compared to the food product with hyaluronic acid or second texturizing agent alone. The effect on texture may depend on the temperature of the food product. In one embodiment of the invention the viscosity, gel stiffness, and/or mouthfeel of the food product with hyaluronic acid and second texturizing agent is higher compared to the food product with second texturizer or hyaluronic acid alone, when the temperature of the food product is 50-100° C., such as 60-100° C., 75-100° C., or 90-100° C.

In one embodiment hyaluronic acid and second texturizing agent is added together in the form of a texturizing composition.

Texturizing Composition

In one embodiment the invention relates to a texturizing composition comprising hyaluronic acid and a second texturizing agent. A texturizing composition according to the invention is a composition suitable for use in preparation of a food product in order to achieve a desired effect on the texture of the food product. A texturizing composition may comprise further components, e.g. components that are useful for stabilisation, conservation, and/or standardisation of the composition, and/or components that facilitate dispersion and/or solubilisation of hyaluronic acid and/or the second texturizing agent when used for production of a food product. In one embodiment hyaluronic acid and the second texturizing agent accounts for at least 20% (weight/weight) of the texturizing composition, such as at least 40%, at least 60%, at least 70%, at least 80%, or at least 90% (weight/weight) of the texturizing composition. The ratio of hyaluronic acid to second texturizing agent in the texturizing composition may be chosen so as to achieve the desired effect upon the texture of the food product to be prepared, and may vary depending on the food product, the nature of the second texturizing agent, and the effect to be achieved. If the second texturizing agent is starch, the ratio of hyaluronic acid to second texturizing agent (weight/weight) may e.g. be in the range 0.00001-1, such as 0.0001-0.5, 0.001-0.1, or 0.002-0.05. If the second texturizing agent is pectin the ratio of hyaluronic acid to second texturizing agent (weight/weight) may e.g. be in the range 0.0001-100, such as 0.0005-10, or 0.001-1.

Non-Dairy Food Product

A non-dairy food product according to the invention may be any food product, which is not a dairy product. Examples of non-dairy food products according to the invention are e.g. meat products, bread, ready-to-eat-dishes, confectionary products, jam, fruit and vegetable preserves, fruit spreads, jellies, purees of fruit or vegetables, sauces, condiments, mayonnaise, toppings, glazes, icings, bakery fillings, dressings, soups, snacks, cereals, beverages, sport drinks, fiber containing drinks, fruit juices and beverages, coffee, tea, cocoa drinks, chocolate drinks, baby food, pet food, soft and hard jelly gums, and confectionary fillings.

A non-dairy food product according to the invention comprises hyaluronic acid and a second texturizing agent and one or more additional food components. A food component according to the invention is any component suitable for use as an ingredient of a food product, e.g. a product derived from a plant or an animal, such as e.g. meat, fruit, vegetables, egg, or any edible fraction or component derived thereof. In one embodiment of the invention a food product which is not a dairy product is a food product wherein the dry matter comprises less than 20% (weight/weight), such as less than 15%, less than 10%, less than 5%, or less than 1%, dry matter derived from milk. In another embodiment the invention relates to a method for preparing a food product comprising (a) mixing hyaluronic acid and a second texturizing agent with one or more additional food components; and (b) preparing a food product, from the mixture resulting from step (a); wherein the dry matter of the mixture resulting from step (a) comprises less than 20% (weight/weight), such as less than 15%, less than 10%, less than 5%, or less than 1%, dry matter derived from milk. In a further embodiment the invention relates to a method for preparing a food product, which is not a dairy product, comprising (a) mixing hyaluronic acid and a second texturizing agent with one or more additional food components; and (b) preparing a food product, which is not a dairy product, from the mixture resulting from step (a).

Use of texturizing agents for improvement of texture and stability is well known in the art for many food products. Hyaluronic acid and a second texturizing agent may be used analogously to other texturizing agents to achieve an improved texture, such as e.g. an improved mouthfeel, viscosity, gel stiffness, moisture retention, syneresis prevention, emulsion stability, suspension stability, binding, adhesion, gelling, thickening, foam strength, and/or volume expansion. Hyaluronic acid and second texturizing agent may be used in amounts suitable to achieve the desired textural effect and will usually be added in the same way and in the same process step as texturizing agents are usually added to the respective product. In most food products hyaluronic acid and second texturizing agent are mixed with the other raw materials used for manufacture. When appropriate to ensure proper solubilization and/or mixing hyaluronic acid and/or second texturizing agent may be dissolved or suspended in liquid before mixing with further ingredients. The raw material mixture comprising hyaluronic acid and a second texturizing agent may be processed by any suitable method known in the art for manufacture of the food product desired.

In one embodiment the invention relates to a non-dairy food product obtainable by the method of the invention. In a further embodiment the invention relates to a non-dairy food product prepared by the method of the invention.

Meat Product

In one embodiment of the invention the non-dairy food product is a meat product. A meat product may be any food product based on meat. In a preferred embodiment a meat product is a processed meat product, such as e.g. a sausage, meat loaf, comminuted meat product, ground meat, bacon, polony, salami, or pate. A processed meat product may e.g. be manufactured from a meat based emulsion further comprising e.g. salts, spices, milk protein, vegetable ingredients, colouring agents, and/or texturizing agents. The meat based emulsion may be cooked or baked, e.g. in a baking form or after being filled into casing of e.g. plastic, collagen, cellulose, or natural casing. A processed meat product may also be a restructured meat product, such as e.g. restructured ham. A meat product of the invention may undergo processing steps such as e.g. curing, drying, smoking, fermentation, slicing, and/or shredding.

Hyaluronic acid and second texturizing agent may be added to a meat product in any appropriate way. If the meat product is a processed meat product, hyaluronic acid and second texturizing agent may e.g. be mixed into a meat based emulsion. In one embodiment of the invention hyaluronic acid and second texturizing agent is added to a marinade or a pickling liquid. Hyaluronic acid and second texturizing agent may be added to meat by injection and/or pumping of a liquid containing hyaluronic acid and second texturizing agent into the meat and/or tumbling the meat.

Dairy Product

A dairy product according to the invention may be any food product produced on the basis of one or more milk components and/or milk fractions. A Milk component may be any component of milk such as e.g. milk fat, milk protein, casein, whey protein, or lactose. A milk fraction may be any fraction of milk such as e.g. skimmed milk, butter milk, whey, cream, butter, milk treated by ultrafiltration, milk powder, whole milk powder, butter milk powder, or skimmed milk powder.

In the present context milk may be the lacteal secretion of any mammal. Thus, milk may be obtained by milking, e.g., cows, sheep, goats, buffaloes, or camels.

A dairy product may additionally comprise non-milk components, e.g. vegetable components such as e.g. vegetable oil, vegetable protein, and/or vegetable carbohydrates. Dairy products may also comprise further additives such as e.g. enzymes, flavouring agents, microbial cultures, salts, sweeteners, sugars, acids, fruit, fruit juices, or any other component known in the art as a component of, or additive to, a dairy product. Examples of dairy products are e.g. skimmed milk, whole milk, cream, a fermented milk product, cheese, yoghurt, butter, dairy spread, butter milk, acidified milk drink, sour cream, whey based milk drink, ice cream, or a flavoured milk drink.

### EXAMPLES

### Example 1

Materials:

Sodium hyaluronate with average molecular weight of 0.8 MDa.
Wheat starch, Sigma S-5127 (Sigma-Aldrich, St. Louis, USA).
Corn starch, CXPharm 03406 (Cargill Cerestar BVBA, Mechelen, Belgium).
Waxy maize, Cerestar 04201 (Cargill Cerestar BVBA, Mechelen, Belgium).
   Viscosity Determination:

Hyaluronic acid and starch were dissolved in deionised water. For samples at pH 3, citric acid was used for pH adjustment. Viscosity was measured with a Rapid Visco Analyser (Newport Scientific) at a constant speed of 100 rpm. For measurement at 25° C. viscosity was read after 2 minutes, for measurements at 95° C. after 4 minutes. Viscosity is expressed as the average of 20 readings with 4 second intervals, in centipoise (cP).

Results:

Results are presented in Table 1.

TABLE 1

| | Viscosity |
|---|---|
| Sample | (cP) |
| Experiment 1: Viscosity at 25° C. | |
| Corn starch 4% | 6 |
| Hyaluronic acid 0.08% | 25 |
| Corn starch 4% + Hyaluronic acid 0.08% | 58 |
| Experiment 2: Viscosity at 95° C., corn starch | |
| Corn starch 4% | 91 |
| Hyaluronic acid 0.02% | 22 |
| Hyaluronic acid 0.08% | 30 |
| Corn starch 4% + Hyaluronic acid 0.02% | 182 |
| Corn starch 4% + Hyaluronic acid 0.08% | 282 |
| Experiment 3: Viscosity at 95° C., wheat starch | |
| Wheat starch 4% | 24 |
| Hyaluronic acid 0.02% | 22 |
| Hyaluronic acid 0.08% | 30 |
| Wheat starch 4% + Hyaluronic acid 0.02% | 116 |
| Wheat starch 4% + Hyaluronic acid 0.08% | 183 |
| Experiment 4: Viscosity at 95° C., waxy maize starch | |
| Waxy maize starch 4% | 120 |
| Hyaluronic acid 0.02% | 22 |
| Hyaluronic acid 0.08% | 30 |
| Waxy maize starch 4% + Hyaluronic acid 0.02% | 135 |
| Waxy maize starch 4% + Hyaluronic acid 0.08% | 263 |
| Experiment 5: Viscosity at pH 3, waxy maize starch | |
| Waxy maize starch 4% | 1 |
| Hyaluronic acid 0.02% | −4 |
| Hyaluronic acid 0.08% | −4 |
| Waxy maize starch 4% + Hyaluronic acid 0.02% | 21 |
| Waxy maize starch 4% + Hyaluronic acid 0.08% | 20 |

1. A method for preparing a non-dairy food product, comprising:
(a) mixing hyaluronic acid and a second texturizing agent with one or more additional food components; and
(b) preparing a non-dairy food product, from the mixture resulting from step (a).

2. The method of claim 1, wherein the second texturizing agent is a carbohydrate.

3. The method of claim 2, wherein the second texturizing agent is starch, modified starch, pectin, carageenan, locust bean gum, an alginate, agar agar, xanthan gum, guar gum, gellan gum, microcrystalline cellulose, konjac, chitin, chitosan, or any combination thereof.

4. The method of claim 1, wherein the non-dairy food product is a product selected among meat products, bread, ready-to-eat-dishes, confectionary products, jam, fruit and vegetable preserves, fruit spreads, jellies, purees of fruit or vegetables, sauces, condiments, mayonnaise, toppings, glazes, icings, bakery fillings, dressings, soups, snacks, cereals, beverages, sport drinks, fiber containing drinks, fruit juices and beverages, coffee, tea, cocoa drinks, chocolate drinks, baby food, pet food, soft and hard jelly gums, and confectionary fillings.

5. A texturizing composition comprising hyaluronic acid and a second texturizing agent.

6. The texturizing composition of claim 5, wherein the second texturizing agent is a carbohydrate.

7. The texturizing composition of claim 6, wherein the second texturizing agent is starch, modified starch, chitin, chitosan, and/or pectin.

8. A non-dairy food product obtainable by the method of claim 1.

9. A non-dairy food product, comprising hyaluronic acid, a second texturizing agent, and one or more additional food components.
